(19) United States
(12) Patent Application Publication
(10) Pub. No.: US 2012/0169024 A1
(43) Pub. Date: Jul. 5, 2012

(54) Deployable Rocker Panel

(75) Inventors: Patrick Verhee, Koeln (DE); Stefan Lamm, Koeln (DE)

(73) Assignee: FORD GLOBAL TECHNOLOGIES, LLC, Dearborn, MI (US)

(21) Appl. No.: 12/985,069

(22) Filed: Jan. 5, 2011

(51) Int. Cl. B60R 3/00

(52) U.S. Cl. 280/166

(57) ABSTRACT

A vehicle with a deployable rocker panel is provided. The vehicle includes a vehicle frame having a door frame and at least one door panel enclosing the door frame. A rocker panel is mounted adjacent a bottom of the vehicle door frame to provide support to the vehicle in the longitudinal direction. A linear drive assembly is coupled to the rocker panel to move the rocker panel between a stowed position and a deployed position. The linear drive assembly moves the rocker panel substantially along one plane. The linear drive assembly moves the rocker panel to the deployed position when the door panel is opened so that a top surface of the rocker panel is exposed as a step for passenger ingress and egress.

### TECHNICAL FIELD

Various embodiments relate to automotive rocker panels and running boards.

### BACKGROUND

Passenger vehicles that facilitate transportation of multiple passengers have been popular for many years. Utility vehicles, such as sport utility vehicles and pickup trucks, have also been popular in recent years. As utility vehicles have become popular for utilization as passenger vehicles, manufacturers of utility vehicles have incorporated many features into utility vehicles to enhance passenger transportation and comfort.

Utility vehicles are often designed for travel through rough terrain. Additionally, utility vehicles are generally designed to haul cargo, whether in a cargo compartment, a bed of the vehicle, or by towing cargo with a trailer. In order to meet these extreme design requirements, utility vehicles are often provided with a vehicle body that is elevated greater than conventional passenger vehicles. For example, utility vehicles often have a passenger compartment that is provided at a greater height than the passenger compartments for conventional passenger vehicles such as sedans or minivans.

In order to market utility vehicles to consumers of varying physical characteristics, running boards have been provided as an option on utility vehicles. A running board is often embodied as an external step provided on the motor vehicle body to assist a user in entering and exiting the passenger compartment. Rather than requiring the passenger to step all the way up into the passenger compartment of a utility, the passenger may first step on the running board and then step into the passenger compartment.

The prior art has provided running boards that extend laterally from the vehicle body to facilitate ingress and egress to and from the passenger compartment. However, prior art running boards often detract from the external ornamental appearance of the passenger vehicle.

Additionally, stationary prior art running boards often collect dirt, mud, dust or other substances since the running board protrudes outward from the vehicle body. As a passenger egresses the vehicle, the passenger's pant leg may become soiled if it contacts the outward extending running board. Although prior art running boards assist in passengers entering the vehicle compartment, they often provide such difficulties in exiting the vehicle.

In order to minimize the problems with stationary running extending from the vehicle body, the size of the running boards is minimized, both in length and width. However, with a small surface that is not wide or flat enough for a passenger to securely step onto, the passenger may slip or go off-balance while trying to enter or exit the vehicle.

Accordingly, the prior art has offered a retractable running board that extends laterally from the vehicle for use and is retracted towards the vehicle body when not in use. This proposal may allow the larger sized running boards while reducing the amount of dirt, mud, and debris collected, although it is a mechanically complex alternative.

Retractable running boards typically have complex mechanical assembly in order to retract the running board out of view under the vehicle body and then deploy the running board to a step position. The mechanical linkages typically include hinges or pivot assemblies so that the running board can rotate and be tucked underneath the vehicle underbody in a stowed position.

While the prior art retractable running boards may provide some advantages to the stationary running boards, the retractable running boards may impede underbody aerodynamics as well as accumulate dirt, mud and debris underneath the vehicle or be damaged.

Additionally, traditional running boards, whether stationary or retractable, do not provide structural support to vehicle. Running boards must be designed to support the weight of a passenger, and resist weather and long term repetitive use. But the running board does not enhance the structure of the vehicle. Typically, a running board only extends a portion of the distance along the side of the vehicle and therefore does not provide any support in the longitudinal direction.

### SUMMARY

At least one embodiment provides for a vehicle with a deployable rocker panel. The vehicle includes a vehicle frame having a door frame and at least one door panel enclosing the door frame. A rocker panel is mounted adjacent a bottom of the vehicle door frame to provide support to the vehicle in the longitudinal direction. A linear drive assembly is coupled to the rocker panel to move the rocker panel between a stowed position and a deployed position. The linear drive assembly moves the rocker panel substantially along one plane. The linear drive assembly moves the rocker panel to the deployed position when the door panel is opened so that a top surface of the rocker panel is exposed as a step for passenger ingress and egress.

Another embodiment provides that the vehicle further includes a controller operatively connected to the linear drive assembly. The controller controls actuation of the rocker panel. The controller actuates the linear drive assembly to move the rocker panel from the stowed position to the deployed position when the controller receives a signal that the door panel is opening.

Yet another embodiment provides that the controller receives the signal from a key fob.

A further embodiment provides that the controller receives the signal from actuation of a door handle.

An even further embodiment provides that an underbody profile of the vehicle when the rocker panel is in the stowed position is not exceeded during actuation of the rocker panel to the deployed position. When is moved to the deployed position in the underbody profile of the vehicle is maintained in order to avoid collision with underlying obstacles.

Another embodiment provides that the drive assembly includes an electric drive motor. The electric drive motor moves the rocker panel between the stowed position and the deployed position. The controller also includes load detection to prevent the rocker panel from extending if obstructed.

At least one embodiment of the present invention provides for an assembly for a vehicle having a deployable rocker panel. The rocker panel is adapted to be mounted along a bottom of a vehicle door opening to provide support to the vehicle in the longitudinal direction. A drive assembly is coupled to the rocker panel to move the rocker panel substantially along one plane in a linear direction between a stowed and a deployed position. A top surface of the rocker panel is exposed as a step for passenger ingress and egress.

Another embodiment provides that an underbody profile of the assembly in the stowed position is not exceeded during actuation of the rocker panel by the drive assembly. When the rocker panel is in the deployed position the underbody profile is maintained in order to avoid collision with underlying obstacles.

A further embodiment proves that the drive assembly includes at least one telescoping rail for moving the rocker panel between the stowed position and the deployed position.

An even further embodiment provides an electric drive motor for moving the rocker panel between the stowed position and the deployed position.

Yet a further embodiment provides a controller with load detection to prevent the rocker panel from extending if obstructed.

Another embodiment provides that the drive assembly is actuated when the vehicle door is opening. As such, the rocker panel moves to the deployed position as the door vehicle door is opening.

A further embodiment provides an outboard surface of the rocker panel having a rocker fascia along the bottom of the vehicle door when in the stowed position.

An even further embodiment provides that the rocker panel extends along a front door and a rear door panel.

At least one embodiment of the present invention provides an assembly with a deployable rocker panel. The rocker panel is mounted along a bottom of a door opening. A drive assembly is coupled to the rocker panel to move the rocker panel between a stowed and a deployed position. The drive assembly moves the rocker panel in a linear direction so that in the deployed position, a top surface of the rocker panel is exposed as a step for passenger ingress and egress.

Another embodiment provides a controller operatively connected to the drive assembly for controlling actuation of the rocker panel. The controller actuates the drive assembly to move the rocker panel from the stowed position to the deployed position when the controller receives a signal that the vehicle door is opening.

Yet another embodiment provides that the controller receives the signal from a key fob.

Still another embodiment provides that the controller receives the signal from actuation of a door handle.

An even further embodiment provides an underbody profile of the assembly in the stowed position which is not exceeded during actuation and when the rocker panel is in the deployed position in order to avoid collision with underlying obstacles.

Another embodiment provides an outboard surface of the rocker panel provides a rocker fascia along the bottom of the vehicle door.

### BRIEF DESCRIPTION OF THE DRAWINGS

FIG. 1 is a perspective view of a passenger vehicle in accordance with an embodiment of the present invention;

FIG. 2 is a side perspective view of the passenger vehicle of FIG. 1;

FIG. 3 is a side perspective view of the passenger vehicle of FIG. 1, illustrated with a door thereof in an open orientation, illustrating a rocker panel in accordance with an embodiment of the present invention; and

FIG. 4 is a perspective view of a rocker panel assembly according to an embodiment of the present invention.

### DETAILED DESCRIPTION

As required, detailed embodiments of the present invention are disclosed herein; however, it is to be understood that the disclosed embodiments are merely various examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A simplified designed step is needed that optimizes support, compactness, utility, style, footing and passenger assistance.

In a typical vehicle, two or four openings are formed in the body to make space for the doors to fit into. With large openings in the vehicle body, it is difficult to provide sufficient structural rigidity to the vehicle. In fact, early vehicles had a tendency to bend in the middle during front impact collisions. As such, the rocker panel is important structure of the vehicle in order to resist crumpling and to provide structural support to the underbody of the vehicle.

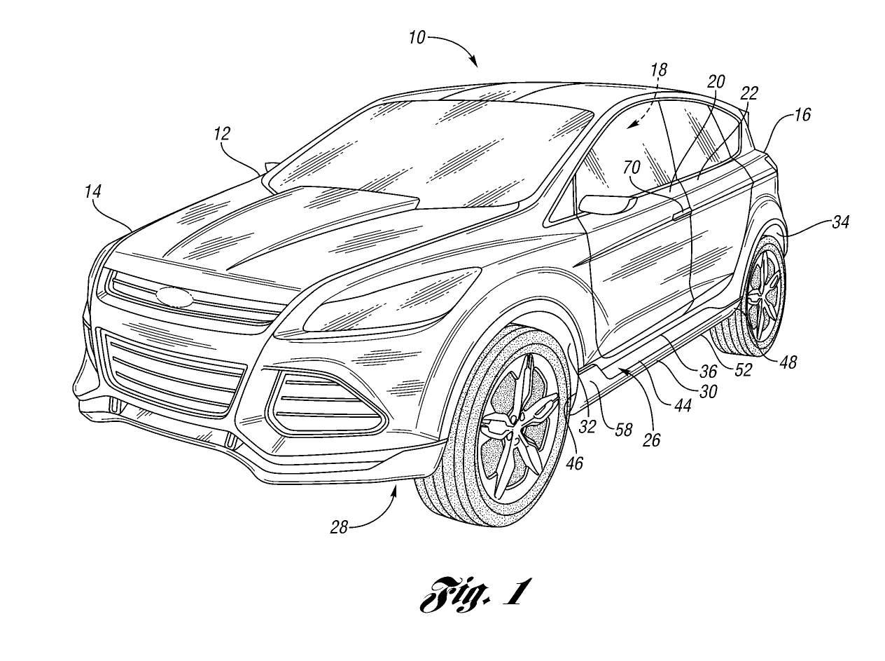

With reference now to FIG. 1, a passenger vehicle is illustrated in according to an embodiment of the present invention. The passenger vehicle is referenced by numeral 10. However, the invention contemplates the passenger vehicle 10 may be a sport utility vehicle, a pickup truck or any other suitable vehicle.

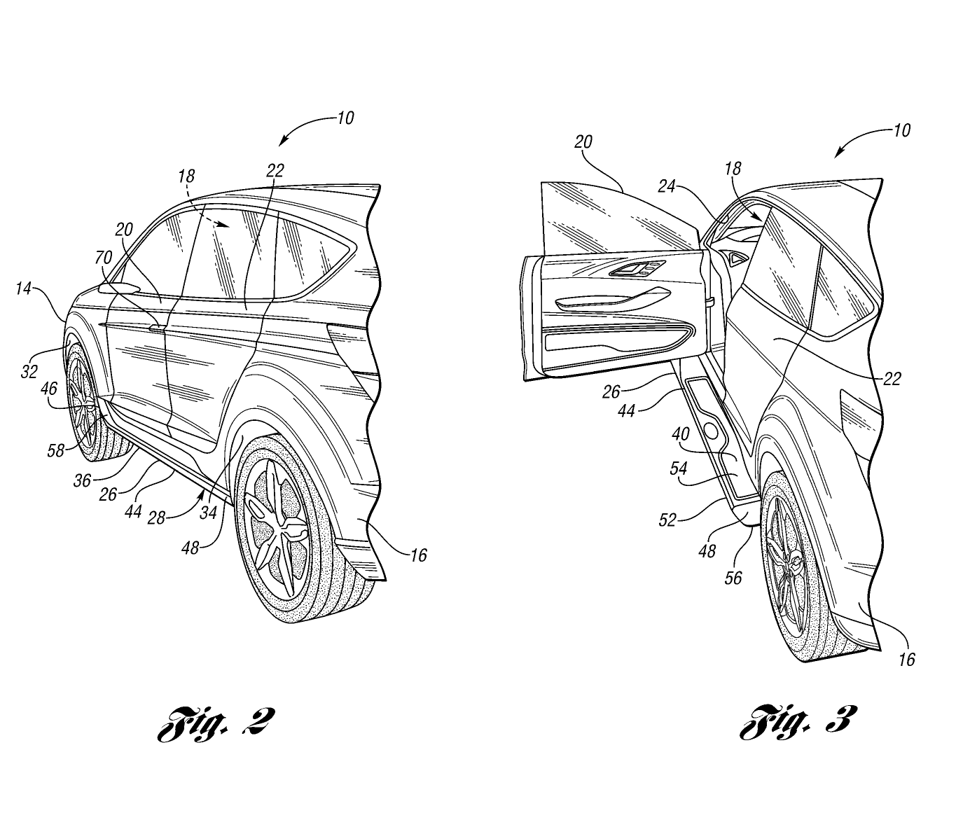

The passenger vehicle 10 includes a vehicle body 12. The vehicle body 12 includes a front end 14, and a rear end 16 with a passenger compartment 18 provided therebetween. The passenger compartment 18 of the depicted embodiment may include two rows for passenger seating, for example, a front row and a back row (not shown). The front row and the back row may each include a pair of doors on opposed lateral sides of the vehicle 10, such as front side door 20 and back side door 22 illustrated in FIGS. 1 and 2. The side doors 20, 22 are illustrated on a right side 28 of the vehicle 10. Although the doors for the left side of the vehicle are not illustrated, the left side doors may generally be a mirror image of the right side doors 20, 22 because the body 12 of the vehicle 10 may be generally symmetrical. The passenger compartment 18 is generally elevated relative to an underlying support surface upon which the vehicle 10 travels.

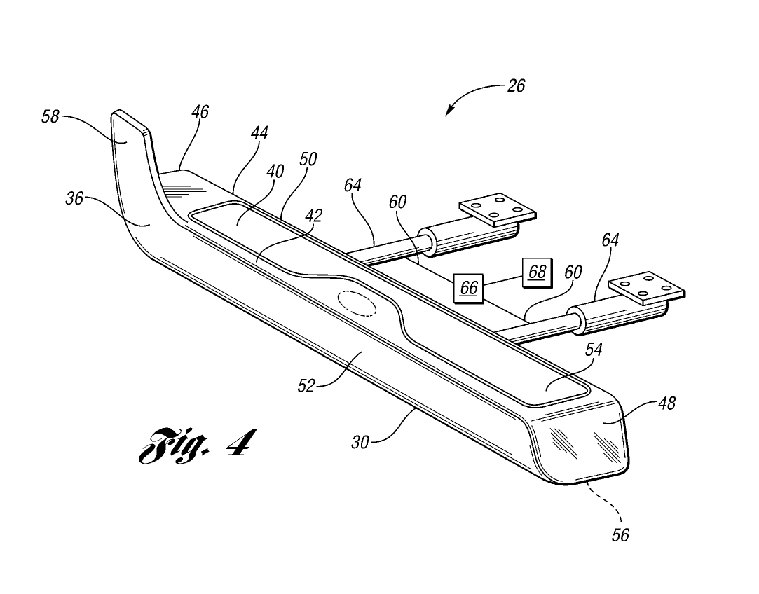

The side doors 20, 22 are illustrated in a closed orientation in FIGS. 1 and 2. Both doors 20, 22 may be translated to an open orientation. Referring now to FIG. 3, an open orientation is illustrated for the front side door 20. For the passenger vehicle 10 of the present invention, all four side doors open in the manner illustrated in FIG. 3, by pivoting about a vertical axis through a hinged connection. Of course, any open orientation is contemplated within the spirit and scope of the present invention. For example, one of the doors could open by translating along a longitudinal track on a side of the vehicle body 12.

Referring to FIG. 3, a door opening 24 is formed in the vehicle body 12 for each door 20, 22. The vehicle 10 may have a vehicle frame (not shown) which may include a door frame which defines at least one side door opening 24. Each door frame provides the door opening 24 through the vehicle body 12 so that the passenger may pass enter and exit the vehicle 10 when the corresponding side door 20, 22, such as front side door 20 is in the open orientation.

A rocker panel assembly 26 may also form part of the vehicle frame. The rocker panel assembly 26 may form the lowest body panel along the side of the vehicle 10 and may define at least a portion of an underbody 28 in the vertical direction. Additionally, the rocker panel 26 may define an outboard edge 30 of the vehicle underbody 28 in the lateral direction.

The rocker panel assembly 26 may extend in the longitudinal direction of the vehicle 10. Additionally, the rocker panel assembly 26 may be located between a front wheel well 32 and a rear wheel well 34. The rocker panel assembly 26 may also provided support for the side doors 20, 22 since the side doors 20, 22 may rest on the rocker panel assembly 26 while closed.

In some vehicles, only the outer edge 30 of the rocker panel assembly 26 is visible when the side doors 20, 22 are closed since the rocker panel assembly 26 supports the bottom of the side doors 20, 22 and provides rigidity to the vehicle in the longitudinal direction. Where the rocker panel assembly 26 is visible, as illustrated in FIGS. 1 and 2, the rocker panel assembly 26 may be part of the vehicle trim and may include trim fascia 36 which adds to the vehicle styling and aesthetic appeal. The rocker panel assembly 26 and trim fascia 36 and may also include the vehicle manufacturer logo or may have ornamental designs.

The rocker panel assembly 26 may be deployable as a step for ingress and egress into the passenger compartment 18. The rocker panel 26 is illustrated in the stowed position when in FIGS. 1 and 2. As illustrated in FIG. 3, the rocker panel assembly 26 may move to the deployed position when the side doors 20, 22 are opened.

The rocker panel assembly 26 may include an elongated step portion 40, when the rocker panel assembly 26 is moved to a deployed position, shown in FIG. 3. The step portion 40 may be formed along a top surface 42 of the rocker panel assembly 26.

Referring to FIG. 4, FIG. 4 illustrates a rocker panel assembly 26 according to one embodiment of the present invention.

The rocker panel assembly 26 includes a rocker panel 44 and a drive assembly 60 for moving the rocker panel 44 between the stowed position and the deployed position. The rocker panel 44 includes the step portion 40 extending along the top surface 42 longitudinally between a front side 46 and rear side 48, and laterally between inboard 50 and outboard 52 ends. The rocker panel 44 may also have a bottom surface 56 opposite the top surface 42.

The front side 46 may form a portion of the front wheel well 32, and likewise the rear side 48 may form a portion of the rear wheel well 34. As such, the front and rear sides 46, 48 may have a curvature which corresponds to the wheel wells 32, 34.

The rocker panel 44 has a top surface 42 with a step portion 40. The step portion 40 may include a tread 54 that provides traction for individuals utilizing the step portion 40. The rocker panel 44 also includes a bottom surface 56. The bottom surface 56 may define a portion of underbody profile 28 of the vehicle. Since the rocker panel 44 moves in linear direction in substantially one plane, the underbody profile 28 of the rocker panel assembly 26 in the stowed position may not be exceeded during actuation from the stowed to the deployed position. By maintaining the underbody profile 28 the rocker panel 44 may avoid collisions with underlying obstacles when it is deployed. Additionally, aerodynamic characteristics of the underbody 28 are not compromised by prior art linkages which pivot or rotate under the underbody of a vehicle.

The rocker panel 44 also includes an outboard surface 52 which may have a class-A surface finish and include trim fascia 36 for styling and aesthetic appeal when the rocker panel assembly 26 is in the stowed position. Additionally, the rocker panel 44 may include trim fascia portions 58 which are mounted to the outboard surface 52, but extend past the outboard surface 52 adjacent the front side 46. The extended trim fascia portions 58 may be flush with the side door panels 20, 22 or other vehicle body panels such as the front body panel 38, as illustrated when the rocker panel assembly 26 is in the stowed position. It is also contemplated that the trim fascia 58 may extend from other surfaces of the rocker panel 44.

The rocker panel assembly 26 includes a linear drive assembly 60 coupled to the rocker panel 44 to move the rocker panel in substantially one plane. The drive assembly 60 may be coupled to the inboard side 50 or the bottom surface 56 of the rocker panel 44, or any other suitable mounting location on the rocker panel 44.

The linear drive assembly 60 may include a slide assembly to move the rocker panel 44 in a linear direction. In one embodiment, the slide assembly 62 may include a pair of telescoping rails 64 spaced apart from each other, as illustrated, or any other suitable number of rails 64 required to support the rocker panel 44 as it is moved along the rails 64. The slide assembly 62 may include any other arrangement for linearly sliding the rocker panel along one plane from the stowed position to the deployed position.

The drive assembly 60 also includes a motor 66 operatively connected to the rocker panel 44. The motor 66 may be an electric motor, or any other suitable motor that may be selectively operated with a controller 68. For example, the motor 66 may be a rotational motor, a linear motor, a hydraulic motor or any other conventional motor. Additionally, the motor 66 may be reversible in order to move the rocker panel 44 to the deployed position, and then return the rocker panel 44 to the stowed position.

The sliding assembly 62 is operatively connected to the motor 66. For example, the sliding assembly 62 may be connected to the motor 66 with a gear assembly (not shown). The gear assembly may include a planetary gear or worm gears which are operatively connected to a linear drive rack on the rails 64, for example. However, any suitable means of transmitting movement between the motor 66 and the slide assembly 62 is contemplated.

The drive assembly 60 may also include a controller 68 to selectively operate the rocker panel assembly 26 to slide the rocker panel 44 between the extended position and the deployed position. The controller 68 may selectively actuate the linear drive assembly 60 when the controller 68 receives a signal that the side door 20, 22 are opening. The rocker panel assembly 26 may move to the deployed position as a vehicle door 20, 22 is opening so that when the door is fully opened, the rocker panel 44 has reached the fully deployed position.

The controller 68 may receive the signal from a key fob (not shown) where the key fob actuates opening of the side doors 20, 22. The controller 68 may also receive the signal from actuation of a door handle 70 by a passenger. It is also contemplated that the controller 68 may receive a signal when the vehicle 10 is placed in park or a passenger manually actuates a signal to deploy the rocker panel 44, or any other suitable signal actuation features. The controller 68 may also include load detection in order to prevent the rocker panel 44 from extending if obstructed.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a vehicle frame having a door frame;
at least one door panel enclosing the door frame;
a rocker panel adapted to be mounted adjacent a bottom of the door frame to provide support to the vehicle in the longitudinal direction; and
a linear drive assembly coupled to the rocker panel to move the rocker panel between a stowed position and a deployed position,
wherein the linear drive assembly moves the rocker panel substantially along one plane to the deployed position when the door panel is opened, a top surface of the rocker panel thereby exposed as a step for passenger ingress and egress.

2. The vehicle according to claim 1 further comprising a controller operatively connected to the linear drive assembly for controlling actuation of the rocker panel, wherein the controller actuates the linear drive assembly to move the rocker panel from the stowed position to the deployed position when the controller receives a signal that the door panel is opening.

3. The vehicle according to claim 2 wherein the controller receives the signal from a key fob.

4. The vehicle according to claim 2 wherein the controller receives the signal from actuation of a door handle.

5. The vehicle according to claim 1 wherein an underbody profile of the vehicle when the rocker panel is in the stowed position is not exceeded during actuation when the rocker panel is moved to the deployed position in order to avoid collision with underlying obstacles.

6. The vehicle according to claim 2 wherein the drive assembly includes an electric drive motor for moving the rocker panel between the stowed position and the deployed position, the controller including load detection to prevent the rocker panel from extending if obstructed.

7. An assembly comprising:
a rocker panel adapted to be mounted along a bottom of a vehicle door opening to provide support to the vehicle in the longitudinal direction; and
a drive assembly coupled to the rocker panel to move the rocker panel substantially along one plane in a linear direction between a stowed and a deployed position,
wherein a top surface of the rocker panel is exposed as a step.

8. The assembly according to claim 7 wherein an underbody profile of the assembly in the stowed position is not exceeded during actuation and when the rocker panel is in the deployed position in order to avoid collision with underlying obstacles.

9. The assembly according to claim 7 wherein the drive assembly includes at least one telescoping rail for moving the rocker panel between the stowed position and the deployed position.

10. The assembly according to claim 7 wherein the drive assembly includes an electric drive motor for moving the rocker panel between the stowed position and the deployed position.

11. The assembly according to claim 7 wherein the drive assembly includes a controller with load detection to prevent the rocker panel from extending if obstructed.

12. The assembly according to claim 7 wherein the drive assembly is actuated when a vehicle door is opening, thereby moving the rocker panel to the deployed position.

13. The assembly according to claim 7 wherein an outboard surface of the rocker panel provides a rocker fascia along the bottom of the vehicle door when in the stowed position.

14. The assembly according to claim 7 wherein the rocker panel extends along a front door and a rear door.

15. An assembly comprising:
a rocker panel mounted along a bottom of a door opening; and
a drive assembly coupled to the rocker panel to move the rocker panel between a stowed and a deployed position,
wherein the drive assembly moves the rocker panel in a linear direction so that in the deployed position, a top surface of the rocker panel is exposed as a step for passenger ingress/egress.

16. The assembly according to claim 15 further comprising a controller operatively connected to the drive assembly for controlling actuation of the rocker panel, wherein the controller actuates the drive assembly to move the rocker panel from the stowed position to the deployed position when the controller receives a signal that a vehicle door is opening.

17. The assembly according to claim 16 wherein the controller receives the signal from a key fob.

18. The assembly according to claim 16 wherein the controller receives the signal from actuation of a door handle.

19. The assembly according to claim 15 wherein an underbody profile of the assembly in the stowed position is not exceeded during actuation and when the rocker panel is in the deployed position in order to avoid collision with underlying obstacles.

20. The assembly according to claim 15 wherein an outboard surface of the rocker panel provides a rocker fascia along the bottom of a vehicle door.
